(19) United States
(12) Patent Application Publication
(10) Pub. No.: US 2023/0176603 A1
(43) Pub. Date: Jun. 8, 2023

(54) CONSTANT VOLTAGE GENERATING CIRCUIT

(71) Applicant: Rohm Co., Ltd., Kyoto (JP)

(72) Inventor: Hironori Sumitomo, Kyoto (JP)

(21) Appl. No.: 17/923,673

(22) PCT Filed: May 14, 2021
(86) PCT No.: PCT/JP2021/018323

§ 371 Date: Nov. 7, 2022

(30) Foreign Application Priority Data
May 27, 2020 (JP) 2020092226

(51) Int. Cl. G05F 3/24

(52) U.S. Cl. CPC G05F 3/24

(57) ABSTRACT

For example, a constant voltage generating circuit includes a first transistor and a second transistor, a first resistor configured to be connected between the gate and the source of the first transistor, a second resistor configured to pass a current with a value equal to that of the current flowing through the first resistor. A first constant voltage is generated by using the difference between the gate-source voltages of the first and second transistors and the terminal-to-terminal voltage across the second resistor.

### TECHNICAL FIELD

The invention disclosed in this specification relates to a constant voltage generating circuit.

### BACKGROUND ART

A constant voltage generating circuit using the difference in the work functions at the gates is known. (For example, see Non-Patent Document 1)

### CITATION LIST

### Non-Patent Literature

Non-Patent Document 1: HENRI J. OGUEY, MEMER, IEEE, AND BERNARD GERBER, “MOS Voltage Reference Based on Polysilicon Gate Work Function Difference”, IEEE JOURNAL OF SOLID-STATE CIRCUITS, VOL. SC-15, NO. 3, JUNE 1980

### SUMMARY OF INVENTION

### Technical Problem

Though, the known constant voltage generating circuit had room for improvement in terms of compensation for temperature characteristic.

### Solution to Problem

For example, according to what is disclosed herein, a constant voltage generating circuit includes a first transistor and a second transistor, a first resistor configured to be connected between the gate and the source of the first transistor, a second resistor configured to pass a current with a value equal to that of the current flowing through the first resistor. A first constant voltage is generated by using the difference between the gate-source voltages of the first and second transistors and the terminal-to-terminal voltage across the second resistor.

For another example, according to what is disclosed herein, a constant voltage generating circuit includes a first transistor and a second transistor can have, at their gates, different work functions respectively, a first resistor, a second resistor, a third resistor, and a fourth resistor. A first terminal of the second resistor can be connected to a source of the second transistor, a source of the first transistor and a second terminal of the second resistor can be both connected to a first terminal of the first resistor, a first terminal of the third resistor can be connected to a gate of the second transistor, a second terminal of the third resistor and a first terminal of the fourth resistor can be both connected to a gate of the first transistor, and a first constant voltage can be output from the gate of the second transistor.

Other features, elements, steps, advantages, and characteristics will be more apparent from the description of embodiments and accompanying drawings which follows.

### Advantageous Effects of Invention

With a constant voltage generating circuit disclosed herein, it is possible to compensate the temperature characteristic with a simple configuration.

### BRIEF DESCRIPTION OF DRAWINGS

FIG. 1 is a diagram showing one comparative example of a constant voltage generating circuit.

FIG. 2 is a diagram showing a temperature characteristic of a differential voltage in a comparative example.

FIG. 3 is a diagram showing a first embodiment of the constant voltage generating circuit.

FIG. 4 is a diagram showing the temperature characteristics of the voltage at relevant points in the first embodiment.

FIG. 5 is a diagram showing a second embodiment of the constant voltage generating circuit.

FIG. 6 is a diagram showing a third embodiment of the constant voltage generating circuit.

FIG. 7 is a diagram showing a fourth embodiment of the constant voltage generating circuit.

FIG. 8 is a diagram showing a fifth embodiment of the constant voltage generating circuit.

FIG. 9 is a diagram showing a sixth embodiment of the constant voltage generating circuit.

FIG. 10 is a diagram showing a seventh embodiment of the constant voltage generating circuit.

FIG. 11 is a diagram showing an eighth embodiment of the constant voltage generating circuit.

FIG. 12 is a diagram showing a ninth embodiment of the constant voltage generating circuit.

### DESCRIPTION OF EMBODIMENTS

<Comparative example> First, prior to the description of novel embodiments of constant voltage generating circuits, a comparative example to be compared with them will be described briefly.

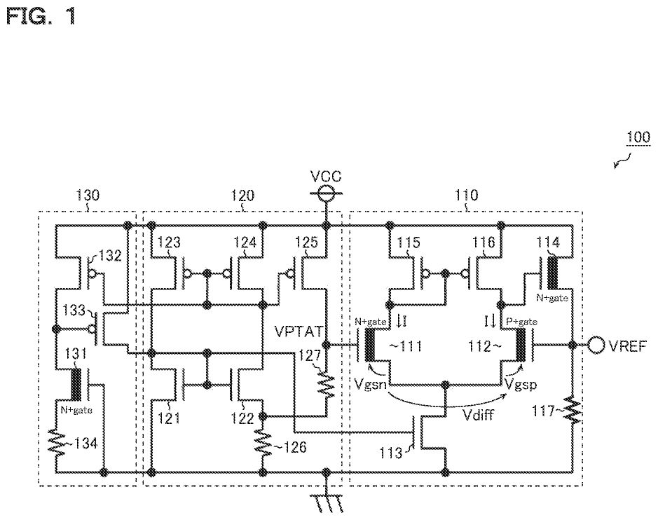

FIG. 1 is a diagram showing one comparative example of a constant voltage generating circuit. The constant voltage generating circuit 100 of this comparative example includes a constant voltage generator 110, a PTAT (proportional to absolute temperature) voltage generator 120, and a starter 130.

The constant voltage generator 110 includes NMOSFETs 111 to 114, PMOSFETs 115 and 116, and a resistor 117. The NMOSFETs 111 and 114 are of the depression type in which the gate is doped with a p-type dopant. By contrast, the NMOSFET 113 and the PMOSFETs 115 and 116 are all of the enhancement type.

The sources of the PMOSFETs 115 and 116 and the drain of the NMOSFET 114 are all connected to a power terminal (that is, an application terminal for a supply voltage VCC). The gates of the PMOSFETs 115 and 116 are both connected to the drain of the PMOSFET 115. The drain of the PMOSFET 115 is connected to the drain of the NMOSFET 111. The drain of the PMOSFET 116 is connected to the drain of the NMOSFET 112 and to the gate of the NMOSFET 114. The gate of the NMOSFET 111 is connected to the output terminal for the PTAT voltage generator 120 (that is, an application terminal for a PTAT voltage VPTAT). The gate of the NMOSFET 112 and the source of the NMOSFET 114 are connected to an output terminal for a constant voltage VREF and to the first terminal of the resistor 117. The sources of the NMOSFETs 111 and 112 are both connected to the drain of the NMOSFET 113. The source of the NMOSFET 113 and the second terminal of the resistor 117 are both connected to a ground terminal.

The PTAT voltage generator 120 includes NMOSFETs 121 and 122, PMOSFETs 123 to 125, and resistors 126 and 127. The NMOSFETs 121 and 122, and the PMOSFETs 123 to 125 are all of the enhancement type.

The sources of the PMOSFETs 123, 124 and 125 are all connected to the power terminal. The gates of the PMOSFETs 123, 124 and 125 are all connected to the drain of the PMOSFET 124. The drains of the PMOSFETs 123 and 124 are connected to the drains of the NMOSFETs 121 and 122 respectively. The gates of the NMOSFETs 121 and 122 are both connected to the drain of the NMOSFET 121. The drain of the PMOSFET 125 is connected to the output terminal for the PTAT voltage VPTAT and to the first terminal of the resistor 127. The source of the NMOSFET 122 is connected to the first terminal of the resistor 126 and to the second terminal of the resistor 127. the source of the NMOSFET 121 and the second terminal of the resistor 126 are both connected to the ground terminal.

The starter 130 includes an NMOSFET 131. PMOSFETs 132 and 133, and a resistor 134. The NMOSFET 131 is of the depression type in which the gate is doped with an n-type dopant. By contrast, the PMOSFET 132 and 133 are both of the enhancement type.

The sources of the PMOSFETs 132 and 133 are both connected to the power terminal. The drain of the PMOSFET 132 is connected to the drain of the NMOSFET 131 and to the gate of the PMOSFET 133. The gate of the PMOSFET 132 is connected to the gate of each of the PMOSFETs 123, 124, and 125. The drain of the PMOSFET 133 is connected to the gate of each of the NMOSFETs 113, 121, and 122. The source of the NMOSFET 131 is connected to the first terminal of the resistor 134. The gate of the NMOSFET 131 and the second terminal of the resistor 134 are both connected to the ground terminal.

In the constant voltage generating circuit 100 (in particular, the constant voltage generator 110) of this comparative example, when a current I of an equal value is flowing in the drain of each of the NMOSFETs 111 and 112, which have different work functions at the gates, the differential voltage Vdiff between the gate-source voltage Vgsn of the NMOSFET 111 and the gate-source voltage Vgsp of the NMOSFET 112 (=Vgsp−Vgsn) has a constant value. Thus, a constant voltage VREF can be generated by using this differential voltage Vdiff.

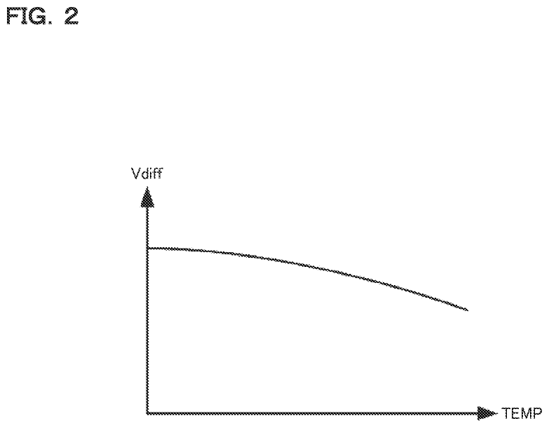

FIG. 2 is a diagram showing the temperature characteristic of the differential voltage Vdiff in this comparative example. The differential voltage Vdiff is approximately equal to the band gap voltage of silicon. Accordingly, as shown in the diagram, the differential voltage Vdiff has a negative temperature characteristic.

Thus, in the constant voltage generating circuit 100 of this comparative example, a PTAT voltage VPTAT that has a positive temperature characteristic is generated in the PTAT voltage generator 120 and it is applied to the gate of the NMOSFET 111 to cancel the negative temperature characteristic of the differential voltage Vdiff so that the constant voltage VREF (=Vdiff+VPTAT) has a close to flat temperature characteristic.

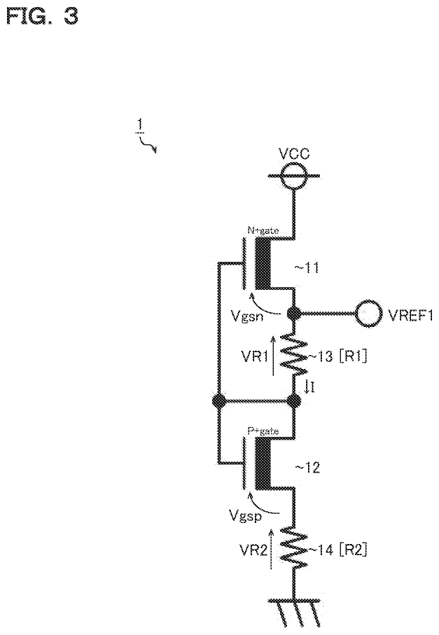

Inconveniently, this configuration requires the PTAT voltage generator 120 (and the starter 130 accompanying it), and thus has a large circuit scale. Hereinafter, novel embodiments free from such inconvenience will be presented.

<First embodiment> FIG. 3 is a diagram showing a constant voltage generating circuit according to a first embodiment. The constant voltage generating circuit 1 of this embodiment includes NMOSFETs 11 and 12 and resistors 13 and 14 (with resistance values R1 and R2).

The NMOSFET 11 is of the depression type in which the gate is doped with an n-type dopant. By contrast, the NMOSFET 12 is of the depression type in which the gate is doped with a p-type dopant. That is, the NMOSFETs 11 and 12 correspond respectively to a first and a second transistor that have different work functions at the gates.

The drain of the NMOSFET 11 is connected to a power terminal. The source of the NMOSFET 11 is connected to an output terminal for a first constant voltage VREF1 and to the first terminal of the resistor 13. The gate of the NMOSFET 11 is connected to the second terminal of the resistor 13. The gate and drain of the NMOSFET 12 are both connected to the gate of the NMOSFET 11. The source of the NMOSFET 12 is connected to the first terminal of the resistor 14. The second terminal of the resistor 14 is connected to a ground terminal.

Thus, through each of the NMOSFETs 11 and 12 connected in series between the power terminal and the ground terminal, a common current I flows. That is, with respect to the gate-source voltages Vgsn and Vgsp of the NMOSFETs 11 and 12, which have different work functions at the gates, their differential voltage Vdiff (=Vgsp−Vgsn) has a constant value (=the band gap voltage of silicon). As a result, the first constant voltage VREF1 (=Vdiff+VR2) drawn from the source of the NMOSFET 11 also has a constant value.

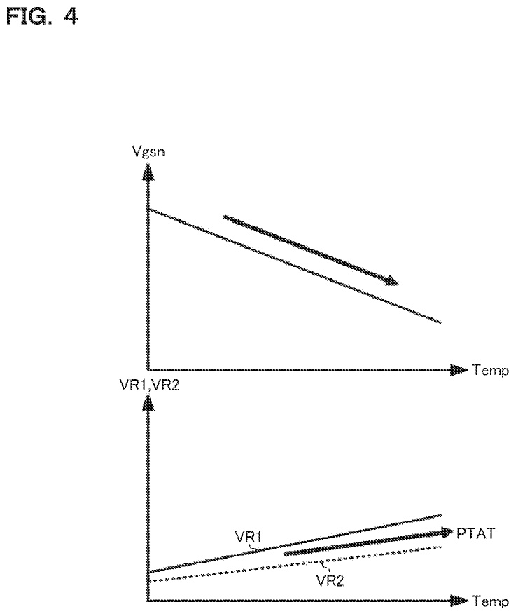

Note that, as mentioned above, the above-described differential voltage Vdiff has a negative temperature characteristic (see FIG. 2 referred to above). By contrast, the terminal-to-terminal voltage VR2 across the resistor 14, which voltage is added to the differential voltage Vdiff, has a positive temperature characteristic (see FIG. 4 referred to later). Thus, it is possible to cancel the negative temperature characteristic of the differential voltage Vdiff so that the first constant voltage VREF1 (=Vdiff+VR2) has a close to flat temperature characteristic.

The resistor 13 corresponds to a first resistor connected between the gate and source of the NMOSFET 11. The resistor 14 corresponds to a second resistor through which flows a current with a value equal to that of the current I (=VR1/R1) flowing through the resistor 13.

Thus, with the constant voltage generating circuit 1 of this embodiment, it is possible. without using the PTAT voltage generator 120 with a large circuit scale (see FIG. 1 mentioned above), by using instead the resistors 13 and 14, to generate the terminal-to-terminal voltage VR2 (=PTAT voltage) with a positive temperature characteristic, and thereby to compensate the temperature characteristic of the first constant voltage VREF1. The NMOSFET 11 is of the depression type, and thus the above-mentioned starter 130 (see FIG. 1 above) is no longer necessary.

Incidentally, in the constant voltage generating circuit 1 of this embodiment, as a technique for giving different work functions at gates, the gates of NMOSFETs 11 and 12, which are both of the depression types, are doped with dopants of different conductivity types (n- and p-types).

With that technique, the NMOSFET 11 and 12 can be given a common device structure (in particularly, in a part below the gate). This gives high insusceptibility to manufacturing variations as compared to, for example, a configuration that generates a constant voltage with a combination of MOSFETs of the depression and enhancement types (so-called an ED-type reference voltage source).

Note that there are other techniques than that mentioned above for giving different work functions at gates is not limited to the above; for example, it can be achieved by giving a difference in W/L (=the ratio of channel width to channel length) or by giving a difference in the concentration of dopants.

Next, the principle of operation whereby the terminal-to-terminal voltage VR2 across the resistor 14 comes to have a positive temperature characteristic will be described referring to the drawings.

FIG. 4 is a diagram showing the temperature characteristics of the voltages at relevant points in the first embodiment (the upper part showing the gate-source voltage Vgsn of the NMOSFET 11 and the lower part showing the terminal-to-terminal voltages VR1 (solid line) and VR2 (broken line) of the resistors 13 and 14 respectively).

As shown in the figure, the gate-source voltage Vgsn of the NMOSFET 11 has a negative temperature characteristic. Accordingly, the terminal-to-terminal voltage VR1 across the resistor 13 (=−Vgsn) has a positive temperature characteristic contrary to the gate-source voltage Vgsn of the NMOSFET 11. The current I flowing through the resistor 13 has a current value (=VR1/R1) which is equal to the terminal-to-terminal voltage VR1 across the resistor 13 divided by the resistance value R1.

The resistors 13 and 14 are connected in series between the power terminal and the ground terminal, and the current I flowing through the resistor 13 flows also through the resistor 14; thus the terminal-to-terminal voltage VR2 across the resistor 14 has a voltage value (=R2×I) which is equal to the resistance value R2 of the resistor 14 multiplied by the current value of the current I. Thus, also the terminal-to-terminal voltage VR2 of the resistor 14 has a positive temperature characteristic.

Here, the terminal-to-terminal voltage VR2 (=R2×I=−Vgsn×(R2/R1)) mentioned above is determined by the ratio (R2/R1) of the resistant values R1 and R2. Thus, by properly adjusting the ratio of the resistance values R1 and R2, the first constant voltage VREF1 can be given a close to flat temperature characteristic.

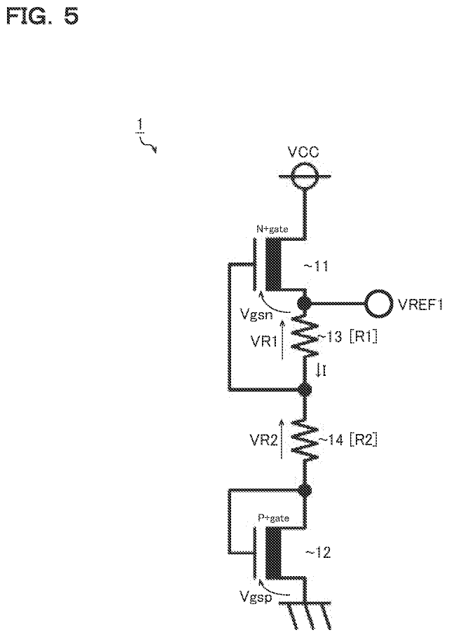

The resistors 13 and 14 only need to be elements of the same type and those elements' own temperature characteristics do not matter. For example, as the resistors 13 and 14, it is possible to use base resistors with a positive temperature characteristic or polysilicon resistors with a negative temperature characteristic. The former can be used if priority is given to giving the elements themselves a positive temperature characteristic: the latter can be used if priority is given to reducing the circuit area.

<Second embodiment> FIG. 5 is a diagram showing a constant voltage generating circuit according to a second embodiment. The constant voltage generating circuit 1 of this embodiment is based on the first embodiment (FIG. 3), but differs from it in where the resistor 14 is inserted.

Specifically, in the constant voltage generating circuit 1 of this embodiment, the gate of the NMOSFET 11 is connected to the second terminal of the resistor 13 and to the first terminal of the resistor 14. The gate and drain of the NMOSFET 12 are both connected to the second terminal of the resistor 14. The source of the NMOSFET 12 is connected to the ground terminal.

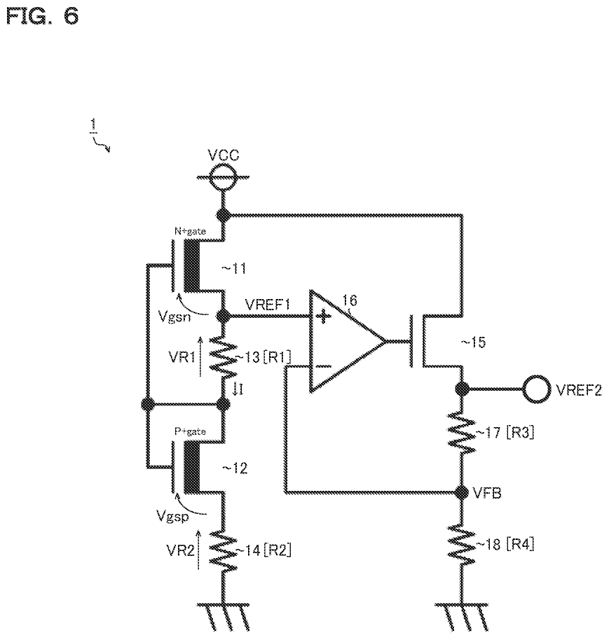

Thus, the resistor 14 can be inserted at the drain side of the NMOSFET 12 instead of at the source side of the NMOSFET 12.

<Third embodiment> FIG. 6 is a diagram showing a constant voltage generating circuit according to a third embodiment. The constant voltage generating circuit 1 of this embodiment is based on the previously-described first embodiment (FIG. 3), and further includes an NMOSFET 15, an operational amplifier 16, and resistors 17 and 18 (with resistance values R3 and R4). The NMOSFET 15 is of the enhancement type.

The drain of the NMOSFET 15 is connected to the drain of the NMOSFET 11. The source of the NMOSFET 15 is connected to an output terminal for a second constant voltage VREF2 and to the first terminal of the resistor 17. The second terminal of the resistor 17 and the first terminal of the resistor 18 are, as an output terminal for a feedback voltage VFB (a division voltage of the second constant voltage VREF2), connected to an inverting input terminal (−) of the operational amplifier 16. The second terminal of the resistor 18 is connected to the ground terminal.

The operational amplifier 16 drives the gate of the NMOSFET 15 to imaginarily short-circuit together the first constant voltage VREF1, which is input to the non-inverting input terminal (+) of the operational amplifier 16, and the feedback voltage VFB (=VREF2×[R4/(R3+R4)]) which is input to the inverting input terminal (−) of the operational amplifier 16.

With the constant voltage generating circuit 1 of this embodiment, it is possible to generate the second constant voltage VREF2 (=VREF1×[(R3+R4)/R4]) higher than the first constant voltage VREF1. It is also possible to increase current capacity with respect to a load (not illustrated) connected to an output terminal for the second constant voltage VREF2.

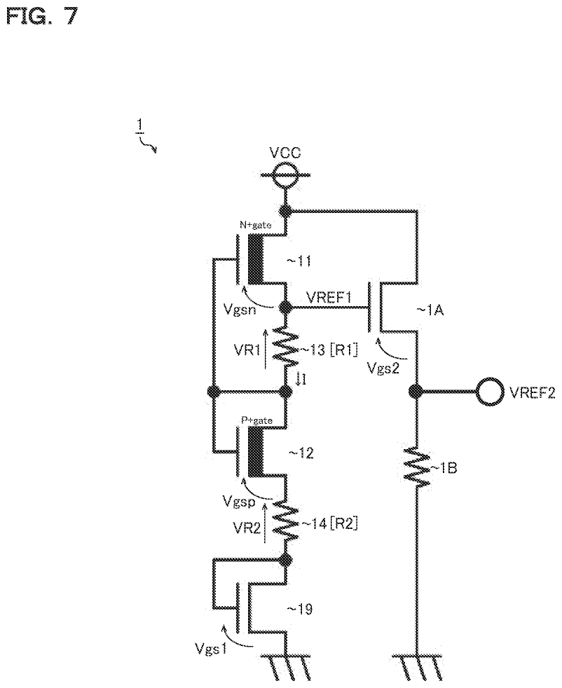

In a case where the only interest is to increase current capacity, the resistors 17 and 18 can be omitted, in which case the inverting input terminal (−) of the operational amplifier 16 can be connected directly to the output terminal for the second constant voltage VREF2.

<Fourth embodiment> FIG. 7 is a diagram showing a constant voltage generating circuit according to a fourth embodiment. The constant voltage generating circuit 1 of this embodiment is based on the previously-described first embodiment (FIG. 3), and further includes NMOSFETs 19 and 1A and a resistor 1B. The NMOSFETs 19 and 1A are both of the enhancement type.

The NMOSFET 19 is diode-connected between the resistor 14 and the ground terminal. Specifically, their interconnection is as follows. The gate and drain of the NMOSFET 19 are both connected to the second terminal of the resistor 14. The source of the NMOSFET 19 is connected to the ground terminal. Adding the NMOSFET 19 in this way permits the first constant voltage VREF1 to be increased by the gate-source voltage Vgs1 (=Vdiff+VR2+Vgs1). It is thus possible to cancel the gate-source voltage Vgs2 of the NMOSFET 1A and to prevent a drop in the second constant voltage VREF2 (=Vdiff+VR2+Vgs1−Vgs2).

The drain of the NMOSFET 1A is connected to the drain of the NMOSFET 11. The gate of the NMOSFET 1A is connected to an application terminal for the first constant voltage VREF1. The source of the NMOSFET 1A is connected to the output terminal for the second constant voltage VREF2 and to the first terminal of the resistor 1B. The second terminal of the resistor 1B is connected to the ground terminal.

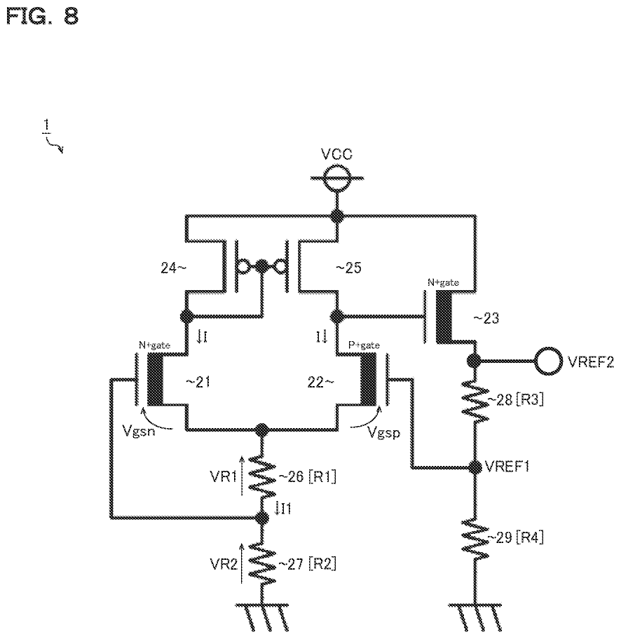

Connected as described above, the NMOSFET 1A functions as a source follower which receives the first constant voltage VREF1 input and outputs the second constant voltage VREF2. Providing such a source follower makes it possible to increase current capacity with respect to a load (not illustrated) connected to the output terminal for the second constant voltage VREF2.

<Fifth embodiment> FIG. 8 is a diagram showing a constant voltage generating circuit according to a fifth embodiment. The constant voltage generating circuit 1 of this embodiment includes NMOSFETs 21 to 23. PMOSFETs 24 and 25, and resistors 26 to 29 (with resistance values R1 to R4).

The NMOSFET 21 is of the depression type in which the gate is doped with an n-type dopant. The NMOSFET 22 is of the depression type in which the gate is doped with a p-type dopant. That is. the NMOSFETs 21 and 22 correspond respectively to a first and a second transistor that have different work functions at the gates.

The NMOSFET 23 is of the depression type in which the gate is doped with an n-type dopant. Note that the NMOSFET 23 can be of the enhancement type. The PMOSFETs 24 and 25 are both of the enhancement type.

The sources of the PMOSFETs 24 and 25 and the drain of the NMOSFET 23 are all connected to the power terminal. The gates of the PMOSFETs 24 and 25 are connected to the drain of the PMOSFET 24. The drain of the PMOSFET 24 is connected to the drain of the NMOSFET 21. The drain of the PMOSFET 25 is connected to the drain of the NMOSFET 22 and to the gate of the NMOSFET 23. The sources of the NMOSFETs 21 and 22 are both connected to the first terminal of the resistor 26. The second terminal of the resistor 26 and the first terminal of the resistor 27 are both connected to the gate of the NMOSFET 21. The source of the NMOSFET 23 is connected to the output terminal for the second constant voltage VREF2 and to the first terminal of the resistor 28. The second terminal of the resistor 28 and the first terminal of the resistor 29 are both connected to the gate of the NMOSFET 22. The second terminals of the resistors 27 and 29 are both connected to the ground terminal.

In the constant voltage generating circuit 1 of this embodiment, through the drain of each of the NMOSFETs 21 and 22, which have different work functions at the gates, a current I of an equal value is passed from the current mirror formed by the PMOSFETs 24 and 25. Thus, the differential voltage Vdiff (=Vgsp−Vgsn) between the gate-source voltage Vgsn of the NMOSFET 21 and the gate-source voltage Vgsp of the NMOSFET 22 has a constant value. As a result, the first constant voltage VREF1 (=Vdiff+VR2) appearing at the gate of the NMOSFET 22 has a constant value, and hence the second constant voltage VREF2 (=VREF1×[(R3+R4)/R4]) according to the first constant voltage VREF1 also has a constant value.

The above-mentioned differential voltage Vdiff has a negative temperature characteristic (see FIG. 2 referred to above), and by contrast, the terminal-to-terminal voltage VR2 (=I1×R2=−Vgsn×(R2/R1)) across the resistor 27. which voltage is added to the differential voltage Vdiff, has a positive temperature characteristic (see FIG. 4 referred to above) like the terminal-to-terminal voltage VR1 across the resistor 26 (=−Vgsn). Thus, it is possible to cancel the negative temperature characteristic of the differential voltage Vdiff so that the first constant voltage VREF1 has a close to flat temperature characteristic.

The resistor 26 corresponds to a first resistor connected between the gate and source of the NMOSFET 21. The resistor 27 corresponds to a second resistor through which flows a current with a value equal to that of the current I (=VR1/R1) flowing through the resistor 26.

As described above, with the constant voltage generating circuit 1 of this embodiment, it is possible. without using the PTAT voltage generator 120 with a large circuit scale (see FIG. 1 referred to above), by using instead the resistors 26 and 27, to generate the terminal-to-terminal voltage VR2 (=PTAT voltage) with a positive temperature characteristic, and thereby to compensate the temperature characteristic of the first constant voltage VREF1.

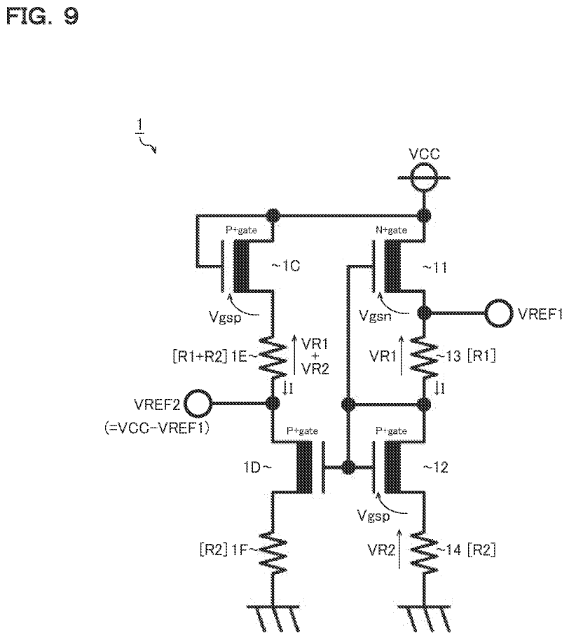

The NMOSFETs 21 and 22 function as a differential pair that performs feedback control for the source follower, and thus compared to the previously-described third embodiment (FIG. 6), no separate operational amplifier is necessary any longer.

<Sixth embodiment> FIG. 9 is a diagram showing a constant voltage generating circuit according to a sixth embodiment. The constant voltage generating circuit 1 of this embodiment is based on the previously-described first embodiment (FIG. 3). and further includes NMOSFETs 1C and 1D and resistors 1E and 1F (with resistance values (R1+R2) and R2). The NMOSFETs 1C and 1D are both of the depression type in which the gate is doped with a p-type dopant.

The gate and drain of the NMOSFET 1C are connected to the drain of the NMOSFET 11. The source of the NMOSFET 1C is connected to the first terminal of the resistor 1E. The second terminal of the resistor 1E and the drain of the NMOSFET 1D are both connected to the output terminal for the second constant voltage VREF2 (=VCC−Vgsn). The gate of the NMOSFET 1D is connected to the gate of the NMOSFET 12. The source of the NMOSFET 1D is connected to the first terminal of the resistor 1F. The second terminal of the resistor 1F is connected to the ground terminal.

In the constant voltage generating circuit 1 configured as described above, the NMOSFETs 12 and 1D constitute a current mirror that mirrors the current I flowing through the drain of the NMOSFET 12 to pass the mirrored current through the drain of the NMOSFET 1D. Thus, through the resistor 1E passes a current with a value equal to that of the current I flowing through the resistor 13.

Here, if the resistant value of the resistor 1E is set to (R1+R2), the terminal-to-terminal voltage (VR1+VR2) appears across the resistor 1E, and thus the VREF2=VCC−Vgsp−(VR1+VR2) holds. Substituting VR1=Vgsn into this formula and arranging it gives VREF2=VCC−(Vgsp−Vgsn+VR2)=VCC−VREF1.

As described above, with the constant voltage generating circuit 1 of this embodiment, it is possible to generate the first constant voltage VREF1 as a ground reference and to generate also a voltage lower than the supply voltage VCC by the first constant voltage VREF1, that is, the second constant voltage VREF2(=VCC−VREF1) as a supply reference.

With focus on the generation of the second constant voltage VREF2, the NMOSFETs 11 and 1C can be understood to correspond respectively to the first and second transistors, which have different work functions at the gates. In this case, the resistor 13 corresponds to the first resistor connected between the gate and source of the NMOSFET 11, and the resistor 14 corresponds to the second resistor through which flows a current with a value equal to that of the current I (=VR1/R1) flowing through the resistor 13.

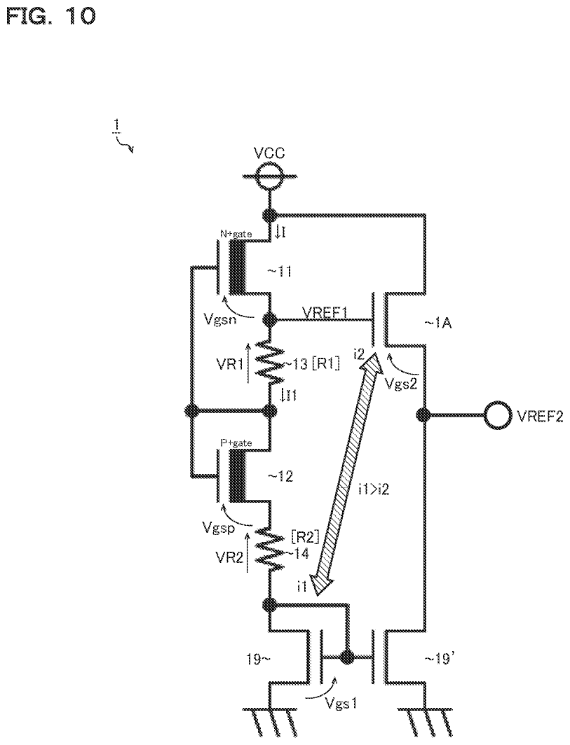

Incidentally, while this embodiment is based on the previously-described first embodiment (FIG. 3), if the first constant voltage VREF1 as a ground reference is not generated, the NMOSFETs 12 and 1D constituting the current mirror does not necessarily have to be of the depression type in which the gate is doped with a p-type dopant and may instead be, for example, of the enhancement type.

<Seventh embodiment> FIG. 10 is a diagram showing a constant voltage generating circuit according to a seventh embodiment. The constant voltage generating circuit 1 of this embodiment is based on the previously-described fourth embodiment (FIG. 7), and includes an NMOSFET 19′ instead of the resistor l B.

The NMOSFET 19′, like the NMOSFET 19, is of the enhancement type. The drain of the NMOSFET 19′ is connected to the output terminal for the second constant voltage VREF2. The gate of the NMOSFET 19′ is connected to the gate of the NMOSFET 19. The source of the NMOSFET 19′ is connected to the ground terminal. So connected, the NMOSFETs 19 and 19′ constitute a current mirror that mirrors the current I flowing through the resistor 13 to draw a current from source follower (=NMOSFET 1A).

Here, the current density i1 in the NMOSFET 19 in the current mirror can be greater than the current density i2 in the NMOSFET 1A in the source follower. With this configuration, the difference between the gate-source voltages Vgs1 and Vgs2 (=Vgs1−Vgs2) of the NMOSFETs 19 and 1A has a positive temperature characteristic, and this helps improve the secondary curvature characteristic of the second constant voltage VREF2 as compared with the previously-described fourth embodiment (FIG. 7).

The current densities i1 and i2 in the NMOSFETs 19 and 1A can be differentiated. if the currents in them have equal values, by differentiating their element sizes and if they have the same element size, by differentiating the current values in them.

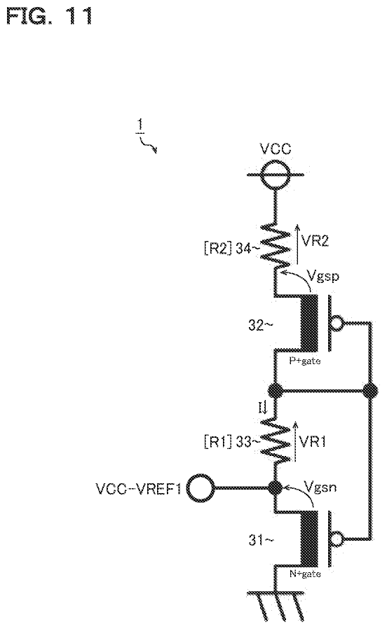

With the constant voltage generating circuit 1 of this embodiment, a PTAT characteristic can be obtained from the difference of the current densities in the NMOSFETs 19 and 1A; thus even if the resistor 14 is omitted. the second constant voltage VREF2 can be given a close to flat temperature characteristic. It should however be noted that, if the resistor 14 is omitted, to obtain the required PTAT characteristic. the difference of the current densities in the NMOSFETs 19 and 1A has to be set to a considerably large value (for example, several hundred times).

<Eighth embodiment> FIG. 11 is a diagram showing a constant voltage generating circuit according to an eighth embodiment. The constant voltage generating circuit 1 of this embodiment includes PMOSFETs 31 and 32 and resistors 33 and 34 (with resistance values R1 and R2).

The PMOSFET 31 is of the depression type in which the gate is doped with an n-type dopant. By contrast, the PMOSFET 32 is of the depression type in which the gate is doped with a p-type dopant. That is, the PMOSFETs 31 and 32 correspond respectively to the first and second transistors that have different work functions at the gates.

The drain of the PMOSFET 31 is connected to the ground terminal. The source of the PMOSFET 31 is connected to the output terminal for the first constant voltage VREF1 (VCC−VREF1) as a supply reference and to the first terminal of the resistor 33. The gate of the PMOSFET 31 is connected to the second terminal of the resistor 33. The gate and drain of the PMOSFET 32 are both connected to the gate of the PMOSFET 31. The source of the PMOSFET 32 is connected to the first terminal of the resistor 34. The second terminal of the resistor 34 is connected to the power terminal.

Thus, through each of the PMOSFETs 31 and 32 connected in series between the power terminal and the ground terminal, a common current I flows. That is, with respect to the gate-source voltages Vgsn and Vgsp of the NMOSFETs 31 and 32, which have different work functions at the gates, their differential voltage Vdiff (=Vgsp−Vgsn) has a constant value (=the band gap voltage of silicon). As a result. the first constant voltage (=VCC−VREF1=VCC−(Vdiff+VR2)) drawn from the source of the NMOSFET 31 also has a constant value.

Note that, as mentioned above, the above-described differential voltage Vdiff has a negative temperature characteristic (see FIG. 2 referred to above). By contrast, the terminal-to-terminal voltage VR2 across the resistor 34, which voltage is added to the differential voltage Vdiff, has a positive temperature characteristic (see FIG. 4 referred to above). Thus, it is possible to cancel the negative temperature characteristic of the differential voltage Vdiff so that the first constant voltage (=VCC−VREF1=VCC−(Vdiff+VR2)) has a close to flat temperature characteristic.

The resistor 33 corresponds to a first resistor connected between the gate and source of the PMOSFET 31. The resistor 34 corresponds to a second resistor through which flows a current with a value equal to that of the current I (=VR1/R1) flowing through the resistor 33.

Thus, also with a configuration in which the NMOSFETs 11 and 12 in the first embodiment (FIG. 3) are replaced with the PMOSFETs 31 and 32 and the output polarity of the constant voltage generating circuit 1 is reversed, it is possible, by using the resistors 33 and 34. to generate the terminal-to-terminal voltage VR2 (=PTAT voltage) with a positive temperature characteristic, and thereby to compensate the temperature characteristic of the first constant voltage (VCC−VREF1).

Though not illustrated specifically, also in the second to seventh embodiments (FIGS. 5 to 10), it is possible to reverse the output polarity by replacing the NMOSFETs with PMOSFETs.

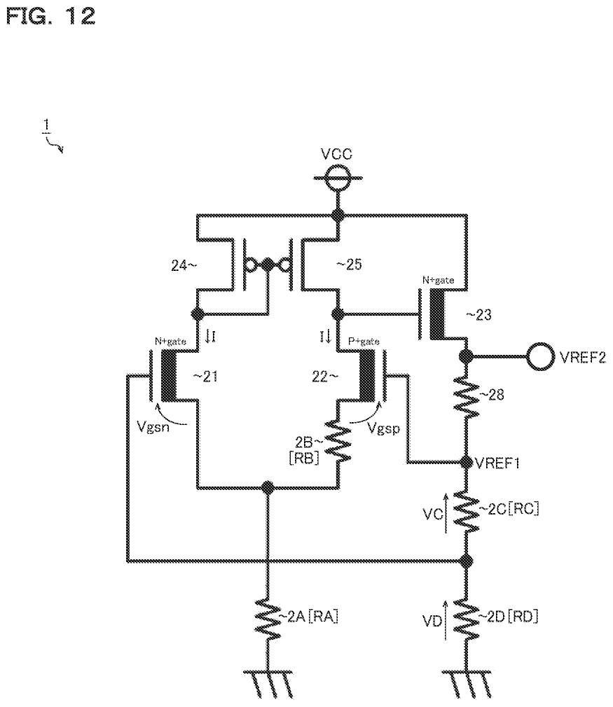

In the first embodiment (FIG. 3) and the like, examples have been described in which the drain of the NMOSFET 11 is directly connected to the power terminal, instead, for another example, it can be connected to the power terminal via a resistor, or another depression-type NMOSFET may be connected between the drain of the NMOSFET 11 and the power terminal. Such connection helps improve the PSRR (power supply rejection ratio).

<Ninth embodiment> FIG. 12 is a diagram showing a constant voltage generating circuit according to a ninth embodiment. The constant voltage generating circuit 1 of this embodiment is based on the previously-described fifth embodiment (FIG. 8), and includes, instead of the resistors 26, 27, and 29, resistors 2A to 2D (with resistance values RA to RD). Accordingly, such components as have already been described are identified by the same reference signs as in FIG. 8, and no overlapping description will be repeated. The following description deals with features specific to this embodiment in detail.

The first terminal of the resistor 2B is connected to the source of the NMOSFET 21. The source of the NMOSFET 21 and the second terminal of the resistor 2B are both connected to the first terminal of the resistor 2A. The first terminal of the resistor 2C is connected to the gate of the NMOSFET 22. The second terminal of the resistor 2C and the first terminal of the resistor 2D are both connected to the gate of the NMOSFET 21. The second terminals of the resistors 2A and 2D are both connected to the reference potential terminal (for example, the ground terminal).

Thus, the constant voltage generating circuit 1 of this embodiment (FIG. 12) is different from the previously-described fifth embodiment (FIG. 8) in that the resistor 2B is connected to the source of the NMOSFET 22 and that the gate of the NMOSFET 21 is connected to a voltage division node of the constant voltage VREF1 or hence the constant voltage VREF2 (that is, the connection node between the resistors 2C and 2D).

In the constant voltage generating circuit 1 of this embodiment, through the drain of each of the NMOSFETs 21 and 22, which have different work functions at the gates, a current I of an equal value is passed from the current mirror formed by the PMOSFETs 24 and 25. Thus, the differential voltage Vdiff (=Vgsp−Vgsn) between the gate-source voltage Vgsn of the NMOSFET 21 and the gate-source voltage Vgsp of the NMOSFET 22 has a constant value.

In the constant voltage generating circuit 1 of this embodiment, the gate-source voltage Vgsn of the NMOSFET 21, the gate-source voltage Vgsp of the NMOSFET 22, the resistance value RA of the resistor 2A, the resistance value RB of the resistor 2B, the terminal-to-terminal voltage VC across the resistor 2C, and the terminal-to-terminal voltage VD across the resistor 2D satisfy Formula (1) below.

$$\begin{matrix}[ Formula 1 ] & \\ VC - \frac{RB}{2 RA} \cdot VD = Vgsp - ( \frac{RB}{2 RA} + 1 ) \cdot Vgsn & ( 1 )\end{matrix}$$

For example, the resistance values RA and RB can be set such that the right-hand side of Formula (1) equals 1.2 V.

Incidentally, while FIG. 12 deals with an example where, as in the previously-described fifth embodiment (FIG. 8), the NMOSFET 21 is of the depression type. employing the circuit configuration of this embodiment allows implementing a constant voltage generating circuit 1 even if the NMOSFET 21 is not of the depression type

<Overview> To follow is an overview of the various embodiments described herein.

For example, according to one aspect of what is disclosed herein, a constant voltage generating circuit includes a first transistor and a second transistor, a first resistor configured to be connected between the gate and the source of the first transistor, a second resistor configured to pass a current with a value equal to that of the current flowing through the first resistor. A first constant voltage is generated by using the difference between the gate-source voltages of the first and second transistors and the terminal-to-terminal voltage across the second resistor. (A first configuration.)

In the constant voltage generating circuit of the first configuration, the first and second transistors can be configured as depression type NMOSFET (n-channel type metal oxide semiconductor field effect transistor) which have gates doped with dopants of different conductivity types respectively. (A second configuration.)

In the constant voltage generating circuit of the first or the second configuration, the first and second transistors can have, at their gates, different work functions respectively. (A third configuration.)

In the constant voltage generating circuit of the second or third configuration, the source of the first transistor can be connected to an output terminal for the first constant voltage and to the first terminal of the first resistor, the gate of the first transistor can be connected to the second terminal of the first resistor, the gate and drain of the second transistor can be connected to the gate of the first transistor, and the source of the second transistor can be connected to the first terminal of the second resistor. (A fourth configuration.)

In the constant voltage generating circuit of the second or third configuration, the source of the first transistor can be connected to an output terminal for the first constant voltage and to the first terminal of the first resistor, the gate of the first transistor can be connected to the second terminal of the first resistor and to the first terminal of the second resistor, the gate and drain of the second transistor can be connected to the second terminal of the second resistor. (A fifth configuration.)

The constant voltage generating circuit of the fourth or fifth configuration can further include a third transistor configured to have its drain connected to the drain of the first transistor and to have its source connected to the output terminal for the second constant voltage, and an operational amplifier configured to drive the third transistor to imaginarily short-circuit together the first constant voltage and the second constant voltage or a division voltage of it. (A sixth configuration.)

The constant voltage generating circuit of the fourth or fifth configuration can further include a source follower configured to receive the first constant voltage input to output a second constant voltage. (A seventh configuration.)

In the constant voltage generating circuit of the second or third configuration, the drains of the first and second transistors can be connected to a current mirror, the sources of the first and second transistors can be connected to the first terminal of the first resistor, the gate of the first transistor can be connected to the second terminal of the first resistor and to the first terminal of the second resistor, and the gate of the second transistor can be connected to an output terminal for the first constant voltage. (An eighth configuration.)

The constant voltage generating circuit of the fourth or fifth configuration can further include a third transistor configured to have its gate and drain connected to the drain of the first transistor, a third resistor configured to be connected between the source of the third transistor and an output terminal for a second constant voltage, and a fourth transistor configured to constitute a current mirror with the second transistor to pass through the third resistor a current with a value equal to the value of the current flowing through the first resistor. (A ninth configuration.)

The constant voltage generating circuit of the seventh configuration can further include a current mirror configured to mirror the current flowing through the first resistor to draw the current from the source follower. The current density in a transistor in the current mirror can be higher than the current density in a transistor constituting the source follower. (A tenth configuration.)

In the constant voltage generating circuit of the first configuration, the first and second transistors can be configured as depression type PMOSFET (p-channel type metal oxide semiconductor field effect transistor) which have gates doped with dopants of different conductivity types respectively. (An eleventh configuration.)

For example, according to another aspect of what is disclosed herein, a constant voltage generating circuit includes a first transistor and a second transistor having, at their gates. different work functions respectively, a first resistor, a second resistor, a third resistor, and a fourth resistor. The first terminal of the second resistor is connected to the source of the second transistor, the source of the first transistor and the second terminal of the second resistor are both connected to the first terminal of the first resistor, the first terminal of the third resistor is connected to the gate of the second transistor, and the second terminal of the third resistor and the first terminal of the fourth resistor are both connected to the gate of the first transistor. A first constant voltage is output from the gate of the second transistor. (A twelfth configuration.)

The constant voltage generating circuit of the twelfth configuration can further include a third transistor configured to have its gate connected to the drain of the second transistor and its source connected to an output terminal for a second constant voltage, and a fifth resistor configured to be connected between the output terminal for the second constant voltage and the gate of the second transistor. (A thirteenth configuration.)

<Other modifications> The various technical features disclosed herein can be modified in various ways without departure from the spirit of the technical ingenuity. It should be understood that the above-described embodiment is in every aspect illustrative and not restrictive. The scope of the present invention is defined not by the description of the embodiment given above but by the appended claims, and encompasses any modifications made without departure from the scope and sense equivalent to those claims.

### REFERENCE SIGNS LIST

1 constant voltage generating circuit
11 NMOSFET (depression type, N+ gate)
12 NMOSFET (depression type, P+ gate)
13, 14 resistor
15 NMOSFET (enhancement type)
16 operational amplifier
17, 18 resistor
19, 19′ NMOSFET (enhancement type)
1A NMOSFET (enhancement type)
1B resistor
1C, 1D NMOSFET (depression type, P+ gate)
1E, 1F resistor
21 NMOSFET (depression type, N+ gate)
22 NMOSFET (depression type, P+ gate)
23 NMOSFET (depression type, N+ gate)
24, 25 PMOSFET (enhancement type)
26, 27, 28, 29, 2A, 2B, 2C, 2D resistor
31 PMOSFET (depression type, N+ gate)
32 PMOSFET (depression type, P+ gate)
33, 34 resistor

1. A constant voltage generating circuit comprising:
a first transistor and a second transistor;
a first resistor configured to be connected between a gate and a source of the first transistor; and
a second resistor configured to pass a current with a value equal to a value of a current flowing through the first resistor,
wherein
a first constant voltage is generated by using a difference between gate-source voltages of the first and second transistors and a terminal-to-terminal voltage across the second resistor.

2. The constant voltage generating circuit according to claim 1, wherein
the first and second transistors are depression-type NMOSFETs which have gates thereof doped with dopants of different conductivity types respectively.

3. The constant voltage generating circuit according to claim 1, wherein
the first and second transistors have at gates thereof different work functions respectively.

4. The constant voltage generating circuit according to claim 2, wherein
the source of the first transistor is connected to an output terminal for the first constant voltage and to a first terminal of the first resistor,
the gate of the first transistor is connected to a second terminal of the first resistor,
a gate and a drain of the second transistor are connected to the gate of the first transistor, and
a source of the second transistor is connected to a first terminal of the second resistor.

5. The constant voltage generating circuit according to claim 2, wherein
the source of the first transistor is connected to an output terminal for the first constant voltage and to a first terminal of the first resistor,
the gate of the first transistor is connected to a second terminal of the first resistor and to a first terminal of the second resistor, and
a gate and a drain of the second transistor are connected to a second terminal of the second transistor.

6. The constant voltage generating circuit according to claim 4, further comprising:
a third transistor configured to have a drain thereof connected to a drain of the first transistor and to have a source thereof connected to an output terminal for a second constant voltage; and
an operational amplifier configured to drive the third transistor to imaginarily short-circuit together the first constant voltage and the second constant voltage or a division voltage thereof.

7. The constant voltage generating circuit according to claim 4, further comprising:
a source follower configured to receive the first constant voltage input to output a second constant voltage.

8. The constant voltage generating circuit according to claim 2, wherein
drains of the first and second transistors are connected to a current mirror,
sources of the first and second transistors are connected to a first terminal of the first resistor,
the gate of the first transistor is connected to a second terminal of the first resistor and a first terminal of the second resistor, and
the gate of the second transistor is connected to an output terminal for the first constant voltage.

9. The constant voltage generating circuit according to claim 4, further comprising:
a third transistor configured to have a gate and a drain thereof connected to a drain of the first transistor;
a third resistor configured to be connected between a source of the third transistor and an output terminal for a second constant voltage; and
a fourth transistor configured to constitute a current mirror with the second transistor to pass through the third resistor a current with a value equal to a value of a current flowing through the first resistor.

10. The constant voltage generating circuit according to claim 7, further comprising:
a current mirror configured to mirror a current flowing through the first resistor to draw the current from the source follower;
wherein
a current density in a transistor in the current mirror is higher than a current density in a transistor constituting the source follower.

11. The constant voltage generating circuit according to claim 1, wherein
the first and second transistors are depression-type PMOSFETs which have gates thereof doped with dopants of different conductivity types respectively.

12. A constant voltage generating circuit comprising:
a first transistor and a second transistor having at gates thereof different work functions; and
a first resistor, a second resistor, a third resistor, and a fourth resistor;
wherein
a first terminal of the second resistor is connected to a source of the second transistor,
a source of the first transistor and a second terminal of the second resistor are both connected to a first terminal of the first resistor,
a first terminal of the third resistor is connected to a gate of the second transistor,
a second terminal of the third resistor and a first terminal of the fourth resistor are both connected to a gate of the first transistor, and
a first constant voltage is output from the gate of the second transistor.

13. The constant voltage generating circuit according to claim 12, further comprising:
a third transistor configured to have
a gate thereof connected to a drain of the second transistor and
a source thereof connected to an output terminal for a second constant voltage; and
a fifth resistor configured to be connected between the output terminal for the second constant voltage and the gate of the second transistor.
